(19) United States
(12) Patent Application Publication
(10) Pub. No.: US 2019/0186667 A1
(43) Pub. Date: Jun. 20, 2019

(54) DEAD SPACE FREE MEASURING TUBE FOR A MEASURING DEVICE AS WELL AS METHOD FOR ITS MANUFACTURE

(71) Applicant: Endress+Hauser Wetzer GmbH+Co. KG, Nesselwang (DE)

(72) Inventors: Stephan Wiedemann, Bihlerdorf (DE); Daniel Koch, Oy-Mittelberg (DE); Angelika Goll, Eisenberg (DE); Markus Mornhinweg, Dießen (DE)

(21) Appl. No.: 16/326,518

(22) PCT Filed: Jul. 25, 2017
(86) PCT No.: PCT/EP2017/068712

§ 371 Date: Feb. 19, 2019

(30) Foreign Application Priority Data
Aug. 19, 2016 (DE) 10 2016 115 426.1

(51) Int. Cl. F16L 41/00; G01D 11/30; G01K 1/14; G01K 13/02; G01F 1/00; G01F 15/18; G01L 19/00

(52) U.S. Cl. CPC F16L 41/008; G01D 11/30; G01K 1/14; G01L 19/0023; G01F 1/00; G01F 15/18; G01K 13/02

(57) ABSTRACT

The present disclosure relates to a measuring tube for conveying a medium, including at least one subsection of a pipeline and at least one immersion body, wherein the immersion body protrudes at least partially into the subsection pipeline. Furthermore, the present disclosure concerns a measuring device having a corresponding measuring tube as well as a method for manufacturing a measuring tube. According to the present disclosure, at least the subsection of the pipeline and the immersion body are manufactured from one piece and using a milling method such as high speed chip removal.

The invention relates to a measuring tube for conveying a medium and having at least one subsection of a pipeline and an immersion body, to a measuring device having such a measuring tube as well as to a method for manufacturing a measuring tube having an immersion body.

Measuring tubes with immersion bodies are applied in a large number of measuring to devices and/or field devices for determining at least one process variable and are manufactured in great variety and sold by the Applicant. The process variable to be determined and/or monitored is, for example, the flow rate of fluid flowing through a measuring tube, or the fill level of a medium in a container. It can, however, also be pressure, density, viscosity, conductivity, temperature or pH-value. Also, optical sensors, such as turbidity or absorption sensors, are known.

For reasons of perspicuity, the following introduction of the description is limited to thermometers. It is noted, however, that the considerations employed in this connection can be directly transferred to other measuring and/or field devices, in the case of which a measuring element or measuring insert is to be integrated into a tube, pipe or pipeline. The measuring element can, furthermore, be arranged within a protection tube. The pipeline, the measuring element or, in given cases, the measuring tube and the protection tube are often connected with one another by means of suitable sealing mechanisms using shape and/or force interlocking, e.g., frictional interlocking, or even directly welded and/or adhered with one another. In such case, however, gaps, joints and/or dead spaces can arise.

Especially in the field of sterile processes, in which a product is made from a raw or starting material by the application of chemical, physical or biological procedures, a thermometer must meet the highest of requirements. In the case of a thermometer integrated into a tube, pipe or pipeline, the measuring insert is frequently arranged in a protection tube, which is located in a subsection of the pipeline, frequently also referred to as a measuring tube. The thermometer must then, on the one hand, be able to register the temperature in the particular process as exactly as possible. This requires, among other things, a good thermal coupling between the measuring insert and the protection tube. On the other hand, the particular embodiment of the measuring tube with the protection tube must also assure a sterile production. In order, for example, to avoid deposits, such as the forming of a biofilm within the pipeline, or within the measuring tube, such should be so embodied that a residue free cleaning is possible. These considerations are explained, for example, in the article “Dead Space Free Protection Tube” at http://www.prozesstechnik-online.de/firmen/-/article/31534493/37267194/Totraumfreies-Schutzrohr/art_co_INSTANCE_0000/maximized/.

An example of a hygienic measuring point is described, for example, in disclosure document DE 102010037994 A1. Such a measuring point for measuring a physical variable is composed of a tube section with an opening, in which an adapter is secured in a sealed manner, which adapter can accommodate a measuring probe. For instance, the tube section has a flattened area containing the opening, by which a planar area arises, and the opening is filled by the adapter. The adapter is, furthermore, connected by a material connection with the flattened tube wall in the plane of the opening or in a plane in parallel with the flattened area.

A further example of a hygienic receiving device for a measuring insert, especially preferably for temperature determination, is known from DE 102012112579 A1. The receiving apparatus has first and second sections, which are separated from one another via a step, wherein the step has a shape, which essentially corresponds to a section of the lateral surface of a tubular wall of a process container, for example, a pipeline or a tank, into which wall the receiving apparatus is insertable.

For both of these examples, the measuring tube must be deformed, especially, changed in cross section. Depending on the properties of the material, especially its plasticity and/or ductility, there can easily arise in the material stresses, which can degrade the stability of the measuring tube. For preventing such problems, the as yet unpublished German patent application No. 102015112424.6 (US 2018216771) discloses a hygienic measuring tube as well as a method for its manufacture, in the case of which the measuring tube is manufactured by means of a generative method, especially by means of a 3D printing method. In this way, stresses within the materials can be prevented, and deformations and/or cross-section changes are not necessary. This German patent application is incorporated by reference in the following.

Starting from the above-described state of the art, an object of the present invention is to provide an alternative for a hygienic measuring tube, especially a hygienic thermometer, in the case of which likewise stresses within the material used for manufacture can be prevented.

The object of the invention is achieved by a measuring tube as defined in claim 1, a measuring device having a measuring tube of the invention, as defined in claim 16, as well as by a method for manufacturing a measuring tube, as defined in claim 17.

Regarding the measuring tube, the object of the invention is achieved by a measuring tube for conveying a medium, comprising at least one subsection of a pipeline, or a pipeline section, and at least one immersion body, wherein the immersion body protrudes at least partially into the subsection of the pipeline, and wherein at least the subsection of the pipeline and the immersion body are manufactured from one piece and by means of a milling method, especially by means of high speed chip removal. Protruding into the measuring tube is, for example, a measuring transducer, configured to measure a chemical and/or physical, measured variable of a medium located in the pipeline. In such case, an immersion body, for example, in the form of a protection tube, is provided, into which protection tube can be introduced, for example, a measuring insert, preferably for determining temperature. The immersion body can, however, also be a pitot tube or other bluff body, which protrudes at least partially inwardly into the pipeline. The pipeline is, for example, a round tube, a square tube, a rectangular tube or a bent tube, composed in such case, for example, of a metal material.

Milling methods are machining manufacturing methods and therewith material removal methods. From a raw part or starting blank, for manufacture of the desired component, excess material is removed mechanically in the form of a chip or chips by means of a milling tool having one or more cutting edges and rotating about the tool axis with high-speed. In order to obtain a desired geometric embodiment, either the milling tool or the raw part or starting blank is moved along a predetermined path. In contrast to drilling, this movement is perpendicular or inclined to the rotational axis of the milling tool. Over the years, many different milling methods have been developed. These have been categorized, for example, according to DIN standard DIN8589, into slab or face, circular, helical, hobbing, profile and form milling methods. The corresponding methods are known per se from the state of the art. Especially advantageous in the case of the present invention is the so-called high speed chip removal method (High Speed Cutting or HSC for short), which in comparison with the above-mentioned milling methods is distinguished by especially high rotational speed (RPM) of the milling tools and, associated therewith, by lower cutting forces and an especially small chip thickness.

Advantageously, the HSC method permits also comparatively thin walled raw parts or workpieces to be worked as well as fulfilling high requirements for surface perfection of the resulting components. Thus, high speed chip removal provides an especially large shape freedom for the components to be manufactured.

Referenced to a measuring tube of the invention, the application of a milling method permits its direct and one-piece manufacture. Especially, a dead space, joint and/or gap free measuring tube with immersion body can be manufactured especially suited for use in sterile applications. In comparison with conventionally manufactured measuring tubes, application of high speed chip removal especially enables achievement of a significantly increased stability, since possible manufacturing related stresses within the measuring tube are reduced. In contrast with measuring tubes, which are composed of a number of subcomponents, furthermore, also sealing mechanisms, welded seams, bonded joints, and the like, can be avoided. This means, as a result, compared with conventional manufacturing process, advantageously, moreover, significantly shortened assembly times.

Moreover, previously not, or only difficulty, realizable forms and/or geometries for the pipeline as well as the immersion body can be selected, forms and/or geometries which can have various technical advantages, especially relative to flow characteristics of the medium.

In a preferred embodiment of the measuring tube, the longitudinal axis of the immersion body extends essentially at a defined angle, especially essentially perpendicularly, to a wall of the subsection of the pipeline. The angle can, in such case, be matched relative to the most varied of requirements for the measuring tube, for example, relative to the flow resistance caused by the immersion body.

Advantageously, at least one transition between a wall of the subsection of the pipeline and a wall of the immersion body is free of dead space. In this way, especially the forming of deposits and/or biofilms within the measuring tube can be prevented. The transition is, as consequence of the manufacture of the invention by means of a milling method and the opportunity associated therewith to manufacture the measuring tube from one piece, furthermore, joint and/or gap free.

In an embodiment, at least one radius in a transition between a wall of the subsection of the pipeline and a wall of the immersion body amounts to at least 3 mm. Such a radius in the transition is especially advantageous for preventing the formation of deposits and/or biofilms.

An especially preferred embodiment of the measuring tube provides that the measuring tube satisfies at least one hygiene regulation, especially based on at least one of the standards of ASME, BPE, 3A or EHEDG. These standards for hygienic applications give, for example, different conditions for a radius in a transition between a wall of the subsection of the pipeline and an immersion body wall extending in parallel with its longitudinal axis. Other specifications concern, for example, the particular surface perfection of the materials, especially in regions facing the medium, as well as selection criteria for the materials to be utilized.

For sterile processes, in which a product is made from a raw or starting material by the application of chemical, physical or biological procedures, international or national regulatory authorities have developed standards, among other things, for the manufacture and embodiment of the utilized equipment. By way of example, reference is made here to the standards of the American Society of Mechanical Engineers (ASME), especially to the so-called “ASME Bioprocessing Equipment—standard” (BPE), the “3-A Sanitary Standards Inc.” (3-A), or even the “European Hygienic Design Group” (EHEDG).

The standards of ASME, BPE and 3A are and, in such case, especially relevant for the American space, while the standard of EHEDG is considered predominantly in Europe. Typical requirements for a component per at least one of these hygiene regulations concern especially the geometry and/or surface of the component, which should be formed in such a manner that no deposits can form, and the component is simple to clean and/or sterilize. The standard of EHEDG forbids, for example, sharp edged transitions. Therefore, for example, an angle between two mutually adjoining surfaces must be >135°, and/or the radius in the region of the transition between two surfaces must be >3.2 mm. Moreover, a surface roughness of <0.78 μm is required. The possibility of being able to fulfill such specifications depends, in such case, among other things, also on the component. Especially in the case of components with small dimensions, it can be that specifications cannot be consistently met. In such cases, one tries to find an adequate design, for example, using a best possible compromise, wherein each case must be separately evaluated.

Advantageously, at least one end region of the subsection of the pipeline is embodied in such a manner that it is connectable, especially by welding or screw fasteners, with a tube element, for example, a bent tube or an additional pipeline. Also, other methods known to those skilled in the art for connection of a measuring tube with a section of a pipeline or the like are possible and fall within the scope of the present invention.

In an embodiment, the measuring tube is essentially in the form of a T or an elbow. In the case of a measuring tube in the form of a T, the immersion body can then, for example, be arranged in the portion, which branches from the main line, which is the branch, which is usually integrated into an existing pipeline. In the case of a measuring tube in the form of an elbow, in turn, the immersion body can, for example, be arranged in the bent portion of the elbow. In such case, an orientation of the immersion body perpendicular to the wall of the bent portion in the direct vicinity of the immersion body can be selected, however, also other angles are, of course, possible. Especially advantageously, a mutual orientation of measuring tube and immersion body can be selected, in the case of which the immersion body protrudes into a straight section of the elbow, wherein, in this case, the length of the immersion body is essentially freely selectable. Furthermore, the geometric embodiment in an end region of the immersion body is essentially freely selectable. The end region of the immersion body can be embodied in the form of a planar area, it can, however, likewise taper in diameter or come to a point. Such an embodiment has, in given cases, an advantageous effect, especially concerning the flow profile of medium flowing through the measuring tube. Since the immersion body, in this case, is not oriented perpendicularly to the flow direction of the medium, it does not act as a type of bluff body for the medium. If the immersion body is embodied in the form of a protection tube for accommodating a sensor element, then a clear increase of the accuracy of measurement of the sensor element results.

In an embodiment, the measuring tube is embodied in the form of an elbow, wherein in at least one end region of the elbow a tube element, especially an at least sectionally bent tube element, is arranged, especially welded. In this way, special requirements for geometry of the measuring tube, especially with reference to an existing pipeline system, can be fulfilled. For example, an elbow can be retrofitted to a T form.

Advantageously, the immersion body is a protection tube for seating a sensor element or measuring insert of a field device. The protection tube is, in such case, preferably embodied to be impervious to the measured substance. The medium can, in turn, be, for example, liquid or gaseous.

The sensor element can be, for example, a measuring insert, especially for registering temperature, preferably in the form of a measuring insert, at whose tip the measuring transducer is arranged, and which can be introduced into the immersion body.

In an especially preferred embodiment of the measuring tube, the cross-sectional area of the immersion body has perpendicular to its longitudinal axis an essentially circularly round, oval, cuboid-shaped, triangular, arrow-shaped, diamond-shaped, circular segment shaped or wing-like geometry. These geometries offer an especially advantageous effect relative to the flow resistance within the pipeline caused by the immersion body. A flow optimized immersion body can, furthermore, lessen vibrations of the immersion body brought about by the flowing medium. It is noted here that besides these examples many other geometries are possible for the immersion body and likewise fall within the scope of the present invention. Many of the examples would not even be implementable without the application of a generative manufacturing method.

In an additional embodiment of the measuring tube, the wall thickness of at least one wall of the immersion body is embodied in such a manner that the volume enclosed by the wall of the immersion body has an inner cross-sectional area, especially a circularly round cross sectional area, essentially matched to the geometry of the sensor element, and the outside cross sectional area surrounding the wall of the immersion body perpendicular to its longitudinal axis has an essentially oval, cuboid-shaped, triangular, arrow-shaped, diamond shaped, circular segment shaped or wing-like geometry. As regards the outer cross-sectional area, the immersion body thus has a flow optimized geometry. For the inner cross-sectional area of the volume enclosed by the wall of the immersion body, in contrast, an inner cross sectional area is selected, especially an essentially circularly round, inner cross sectional area, matched to the geometric dimensions of a sensor element provided in the immersion body. This enables an especially simple and exactly fitting introduction of the sensor element into the immersion body. In the case of a thermometer, this is especially advantageous relative to the thermal coupling between the sensor element and the immersion body, which in this example is usually in the form of a protection tube.

Advantageously, the measuring tube is made of a metal, especially a stainless steel. This material is applied especially frequently in the field of sterile processes, in which a product is made from a raw or starting material by the application of chemical, physical or biological procedures, and, depending on processing, especially of the surfaces, satisfies high hygiene requirements.

The object of the invention is, furthermore, achieved by a measuring device comprising at least one measuring tube of at least one of the described embodiments and a sensor element, which is introduced into the immersion body.

The measuring device serves preferably for determining temperature, wherein the sensor element comprises a measuring transducer for determining temperature. Provided in the measuring device, thus, is, preferably, a thermometer, especially a thermometer having an immersion body in the form of a protection tube.

Regarding the method, the object of the invention is achieved by a method for manufacturing a measuring tube for conveying a medium, wherein the measuring tube comprises a subsection of a pipeline and at least one immersion body, wherein the immersion body protrudes at least partially into the subsection of the pipeline, and wherein at least the subsection of the pipeline and the immersion body are manufactured from one piece and by means of a milling method, especially by means of high speed chip removal.

The advantages described for the apparatus of the invention apply in analogous manner likewise for the method of the invention.

In an embodiment of the method, the measuring tube is at least partially embodied relative to its geometry in the region facing the medium in such a manner that the flow profile of the medium is optimized and/or improves the measuring performance of the sensor element.

The embodiments explained regarding the measuring tube and/or measuring device can be applied mutatis mutandis also to the proposed method and vice versa.

In summary, the use of a milling method according to the invention, especially a high speed chip removal, enables manufacture of a dead space free, gap and joint free measuring tube suitable for hygienic applications. The small chip thickness especially characteristic of high speed chip removal means that typical requirements of established hygienic standards, especially relative to maximum surface roughness or specifications for transitional radii can be directly fulfilled during the milling procedure. Correspondingly, advantageously, no reworkings of the measuring tube are necessary. A special advantage results in the case of small measuring tubes, especially such having a tube diameter of, for instance, 10-30 mm and/or a diameter of the immersion body of, for instance, 6 mm or less. Such measuring tubes are due to their small geometric size even not practical for a subsequent reworking, for example, a polishing procedure.

The invention will now be explained in greater detail based on the appended drawing, the figures of which show as follows:

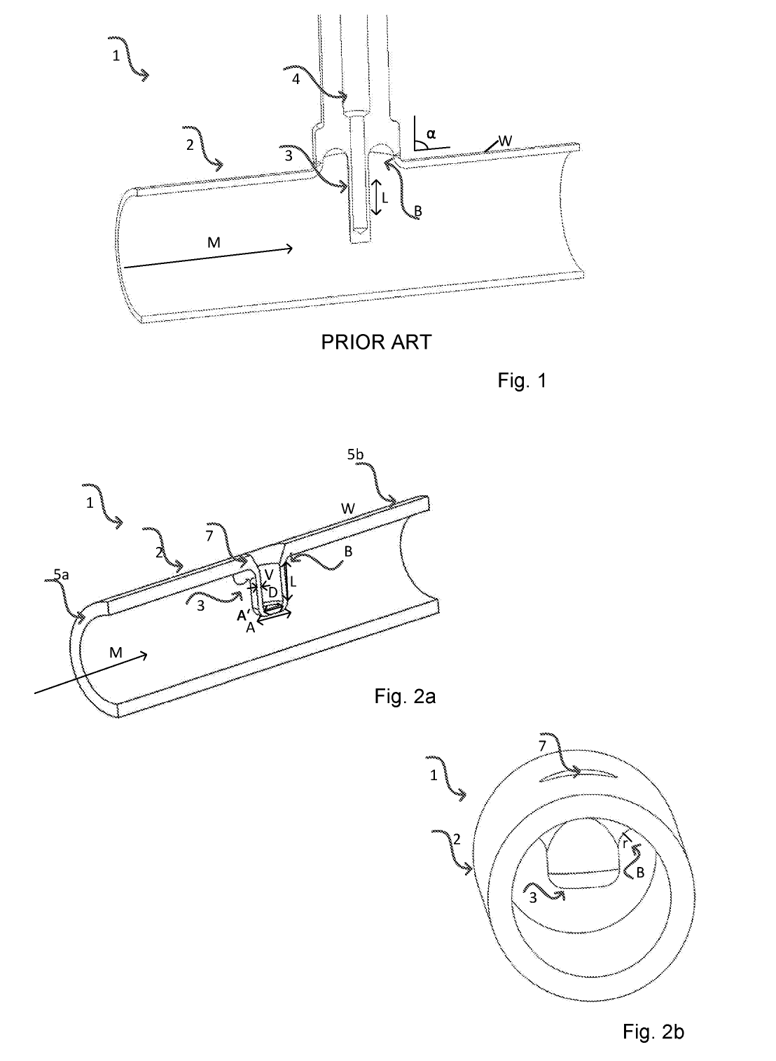

FIG. 1 a schematic representation of a measuring tube with an immersion body of the state of the art,

FIG. 2 a first embodiment of a one piece measuring tube of the invention in the form of a T in two different perspective views a) and b), and

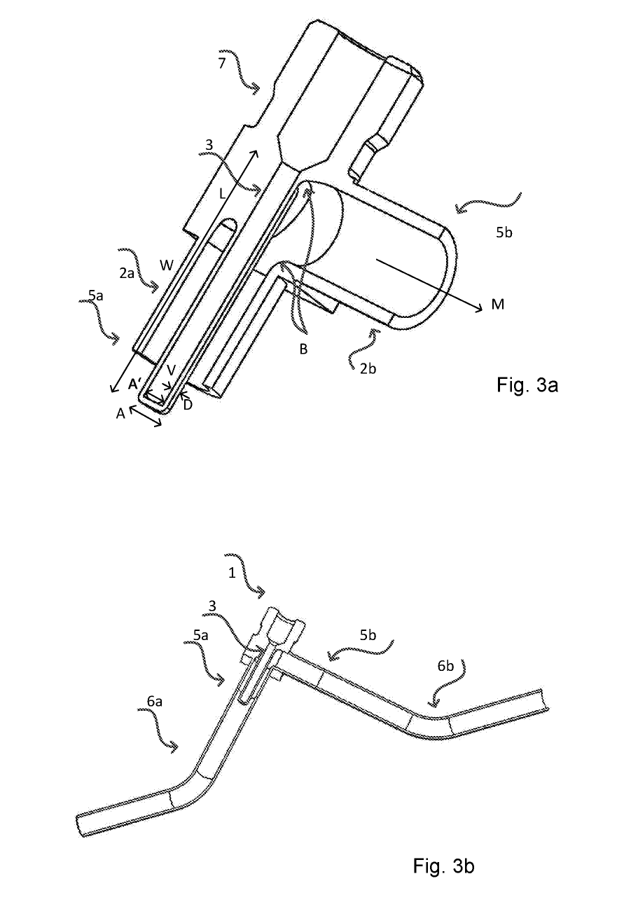

FIG. 3 a second embodiment of a one piece measuring tube of the invention a) in the form of an elbow and b) in the form of an elbow having two welded-on, bent tubes.

FIG. 1 shows a measuring tube 1 of the state of the art in the form of a subsection of a pipeline 2 flowed through by a medium M and an immersion body 3, which protrudes inwardly partially into the subsection of the pipeline 2. This is, thus, a measuring tube 1 having a T form. The longitudinal axis L of the immersion body 3 extends essentially perpendicularly to the wall W of the pipeline 2. It is noted, however, that the angle α between the wall W of the pipeline 2, and the longitudinal axis of the immersion body can also be other than 90°. For the measuring tube 1 shown in FIG. 1, there is always present in the transition B between pipeline 2 and immersion body 3 a dead space, which is especially disadvantageous when the measuring tube 1 is used in the field of sterile processes, in which a product is made from a raw or starting material by the application of chemical, physical or biological procedures.

In the view shown in FIG. 1, a sensor element 4 of a field device is inserted in the immersion body 3 (while here only the sensor element is shown, a field device often further includes at least one electronics unit). In an example of an embodiment, the immersion body 3 can be a protection tube, and the sensor element 4 a thermometer.

FIG. 2a is a schematic representation of a first embodiment of the invention for a measuring tube 1. The longitudinal axis L of the immersion body 3 extends as shown in FIG. 1 essentially perpendicularly to the wall W of the pipeline 2. It is noted, however, that also for a measuring tube 1 of the invention the angle α between the wall of the W of the pipeline 2 and the longitudinal axis of the immersion body can be an angle other than 90°. In contrast with the measuring tube 1 shown in FIG. 1, there is in the case of the embodiment of FIG. 2a, due to the manufacturing of the invention, no dead space in the transition B between pipeline 2 and immersion body 3. This is better shown in the view of FIG. 2b. The radius r in the transition B amounts preferably to at least 3 mm for fulfilling the requirements of established hygienic standards.

According to the invention, thus, a dead space free, gap and joint free measuring tube 1 is provided, which is ideally suited for sterile processes, in which a product is made from a raw or starting material by the application of chemical, physical or biological procedures or for other applications where high hygiene requirements are present, since, due to the character of the measuring tube 1, a residue free cleaning is possible.

Because of the application according to the invention of a milling method, many different embodiment possibilities result for measuring tube 1. Especially, both the cross-sectional area A as well as also the wall thickness D the wall of the immersion body 3 as well as the volume V enclosed by the wall of the immersion body, especially the inner cross-sectional area A′, can be selected according to defined conditions resulting from the process and/or the applied sensor element 4. The wall thickness D the wall of the immersion body 3 can, furthermore, be uniform or nonuniform. The geometries selected for measuring tube 1 aim preferably at optimizing the flow profile of the medium flowing through the measuring tube M and/or at improving the measuring performance of the utilized sensor element. The flow resistance exerted on the medium M by the immersion body 3 can, in such case, also correlate directly with the achievable measuring performance.

Optionally and independently of the additional embodiment of the measuring tube 1, at least one end region 5a, 5b of the subsection of the pipeline 2 is embodied in such a manner that it is connectable, especially weldable or screwable, to a tube element, for example, a bent tube or an additional pipeline (not shown). Likewise optionally, the immersion body 3 can, furthermore, have an attachment feature 7, which can especially be a screw thread, and which serves to secure the a measuring insert 4 in the immersion body 3.

A second advantageous embodiment of a measuring tube 1 of the invention, here in the form of an elbow, is shown in FIG. 3. Also, this embodiment for a measuring tube 1 of the invention is distinguished especially by dead space free transition regions B. The advantages and options for embodiment explained with respect to FIG. 2 hold analogously for the elbow shown in FIG. 3. Already explained reference numerals are not described again.

In FIG. 3, the immersion body 3 extends essentially parallel with wall W of a first portion 2a of the pipeline. A second portion 2b of the pipeline extends, in turn, perpendicularly to the first portion 2a of the pipeline. It is understood, however, that also other angles are possible between the portions 2a, 2b of the pipeline and fall within the scope of the present invention. Advantageously, the embodiment of FIG. 3a enables that the length L of the immersion body 3 is essentially freely selectable and, thus, in contrast to other possible embodiments, can be significantly lengthened. This offers metrological advantages especially in the case of an embodiment of the immersion body 3 as protection tube for seating a sensor element 4 (not shown), especially with reference to the influencing of the flow profile of the medium M by the immersion body 3.

In the case of embodiment of the measuring tube 1 of the invention as an elbow, there results, as shown in FIG. 3b, further the opportunity to connect bent tube elements 6a,6b to one, or, such as here shown, both end regions 5a,5b. For the example shown here, while basically not obligatory, measuring tube 1 corresponds to the embodiment of FIG. 3a. With the variant of the invention shown in FIG. 3b special requirements can be accommodated, for example, integration into an existing pipeline system.

### LIST OF REFERENCE CHARACTERS

1 measuring tube
2 pipeline or subsection of a pipeline
3 immersion body
4 sensor element
5a,5b end regions of the measuring tubes
6a,6b tube elements, e.g. bent tubular pieces
L longitudinal axis of the immersion body
W wall of the pipeline
α angle between W and L
B transition between pipeline and immersion body
D wall thickness of the wall of the immersion body
A cross sectional area of the immersion body
A′ inner cross sectional area of the immersion body
V volume enclosed by the wall of the immersion body

1-17. (canceled)

18. A measuring tube for conveying a medium, the measuring tube comprising:
a subsection of a pipeline and an immersion body having a longitudinal axis, wherein the immersion body protrudes at least partially into the subsection of the pipeline, and wherein at least the subsection of the pipeline and the immersion body are manufactured from one piece using a high-speed chip removal milling method.

19. The measuring tube of claim 18, wherein the longitudinal axis of the immersion body extends at a defined angle relative to a wall of the subsection of the pipeline.

20. The measuring tube of claim 19, wherein the defined angle is substantially perpendicular to the wall of the subsection of the pipeline.

21. The measuring tube of claim 18, wherein at least one transition between a wall of the subsection of the pipeline and a wall of the immersion body is free of dead space.

22. The measuring tube of claim 18, wherein at least one radius in a transition between a wall of the subsection of the pipeline and a wall of the immersion body is at least 3 mm.

23. The measuring tube of claim 18, wherein the measuring tube satisfies at least one hygiene regulation, based at least one of the standards of the American Society of Mechanical Engineers (ASME), ASME Bioprocessing Equipment—standard, 3-A Sanitary Standards Inc. or the European Hygienic Design Group.

24. The measuring tube of claim 18, wherein an end region of the subsection of the pipeline is structured such that the subsection is connectable with a tube element, a bent tube or an additional pipeline.

25. The measuring tube of claim 18, wherein the end region is structured such that the subsection is connectable by either welding or screw fit with the tube element, the bent tube or the additional pipeline.

26. The measuring tube of claim 18, wherein the measuring tube is substantially in the form of a “T” or an elbow.

27. The measuring tube of claim 18, wherein the immersion body includes an attachment feature configured to enable securing a measuring insert in the immersion body.

28. The measuring tube of claim 27, wherein the measuring tube is embodied in the form of an elbow, wherein a tube element is connected to at least one end region of the elbow.

29. The measuring tube of claim 28, wherein the tube element is an at least sectionally bent tube element.

30. The measuring tube of claim 18, wherein the immersion body is a protection tube for seating a sensor element of a field device.

31. The measuring tube of claim 18, wherein, perpendicular to its longitudinal axis, a cross-sectional area of the immersion body has a substantially circularly round, oval, cuboid-shaped, triangular, arrow-shaped, diamond-shaped, circular segment shaped or wing-like geometry.

32. The measuring tube of claim 18, wherein a wall thickness of a wall of the immersion body is embodied such that a volume defined by the wall of the immersion body has an inner cross-sectional area complementary to a geometry of a sensor element, and wherein the wall defines, perpendicular to the longitudinal axis, an outer cross-sectional area of the immersion body that has a substantially oval, cuboid-shaped, triangular, arrow-shaped, diamond-shaped, circular segment shaped or wing-like geometry.

33. The measuring tube of claim 18, wherein the measuring tube is made of a metal, including a stainless steel.

34. A measuring device, comprising:
a measuring tube including a subsection of a pipeline and an immersion body having a longitudinal axis, wherein the immersion body protrudes at least partially into the subsection of the pipeline, and wherein at least the subsection of the pipeline and the immersion body are manufactured from one piece using a high-speed chip removal milling method; and
a sensor element, at least partially disposed within the immersion body.

35. The measuring tube of claim 34, wherein the measuring device is adapted for determining a temperature, and wherein the sensor element includes a measuring transducer for determining temperature.

36. A method for manufacturing a measuring tube for conveying a medium, wherein the measuring tube includes at least one subsection of a pipeline and at least one immersion body, the method comprising:
using a high-speed chip removal milling method to manufacture at least the subsection of the pipeline and the immersion body as one piece such that the immersion body protrudes at least partially into the subsection of the pipeline.

37. The method of claim 36, wherein the measuring tube is manufactured such that a geometry of the measuring tube in a region facing into a flow by which the medium is conveyed yields a flow profile of the medium that is optimized and/or improves measuring performance of a sensor element disposed with in the immersion body.
